(19) United States
(12) Patent Application Publication
(10) Pub. No.: US 2025/0263297 A1
(43) Pub. Date: Aug. 21, 2025

(54) PROCESS FOR MANUFACTURE LITHIUM SALT OF BIS(FLUOROSULFONYL)IMIDE IN SOLID FORM

(71) Applicant: SPECIALTY OPERATIONS FRANCE, Lyon (FR)

(72) Inventors: Joo-Hee Kang, Lyon (FR); Philippe Carvin, Lyon (FR)

(73) Assignee: SPECIALTY OPERATIONS FRANCE, Lyon (FR)

(21) Appl. No.: 18/856,546

(22) PCT Filed: Apr. 12, 2023
(86) PCT No.: PCT/EP2023/059491

§ 371 Date: Oct. 11, 2024

(30) Foreign Application Priority Data
Apr. 21, 2022 (EP) 22305585.6

(51) Int. Cl. C01B 21/086; B01D 11/04; H01M 10/0568

(52) U.S. Cl. CPC C01B 21/086; B01D 11/0403; B01D 11/0488; B01D 11/0492; H01M 10/0568; C01P 2006/40

(57) ABSTRACT

The present disclosure relates to a process for preparing a lithium salt of bis(fluorosulfonyl)imide (LiFSI) in solid form, wherein the LiFSI salt in solid form is extracted from a solution comprising at least one solvent through supercritical anti-solvent extraction. The present invention also relates to the LiFSI in solid form obtained therefrom, as well as the use of such LiFSI in an electrolyte for batteries.

### CROSS-REFERENCE TO RELATED APPLICATION

This application claims priority to earlier European Patent Application No. 22305585.6 filed on 21 Apr. 2022, the whole content of this application being incorporated herein by reference for all purposes.

### TECHNICAL FIELD

The present invention relates to a process for preparing a lithium salt of bis(fluorosulfonyl)imide (LiFSI) in solid form. The present invention also relates to the LiFSI in solid form obtained therefrom, as well as the use of such LiFSI in an electrolyte for batteries.

### BACKGROUND

Bis(fluorosulfonyl)imide and salts thereof, in particular the lithium salt of bis(fluorosulfonyl)imide (LiFSI), are useful compounds in a variety of technical fields, including in battery electrolytes.

The production of LiFSI is described in the literature. Among the various technologies described, the majority uses a fluorination reaction with a fluorinating agent in a solvent.

Notably, WO 2017/090877 (in the name of CLS) describes a method for producing LiFSI comprising the steps of: (1) reacting bis(chlorosulfonyl)imide with a fluorinating reagent in a solvent, followed by treatment with an alkaline reagent, thereby producing ammonium bis(fluorosulfonyl)imide; and (2) reacting the ammonium bis(fluorosulfonyl)imide with a lithium base. The solvent used in step (1) is selected from the group consisting of alkyl ketones, including acetone, methyl ethyl ketone, and methyl isopropyl ketone; alcohols, including methanol, anhydrous ethanol, 1-propanol, and isopropanol; alkyl nitriles, including acetonitrile, and propionitrile; and ethers, including tetrahydrofuran, and dialkoxyalkane. The solvent is then removed by distillation and concentration under reduced pressure.

WO 2012/117961 (in the name of Nippon Soda) describes a process for producing a fluorosulfonyl imide salt. According to examples 1 and 2, ammonium di(fluorosulfonyl)imide is prepared from di(chlorosulfonyl)imide in acetonitrile. The solvent is then removed by distillation under reduced pressure.

JP 2016145147 (in the name of Nippon Shokubai) relates to a method for providing a fluorosulfonyl imide compound represented by the formula (1) by reacting a compound represented by the formula (2) and a compound represented by the composition formula (3) of 1 to 3 equivalence by stoichiometric amount based on 1 mol. of the compound in a presence of a solvent of 0 to 4 mass times of the compound.

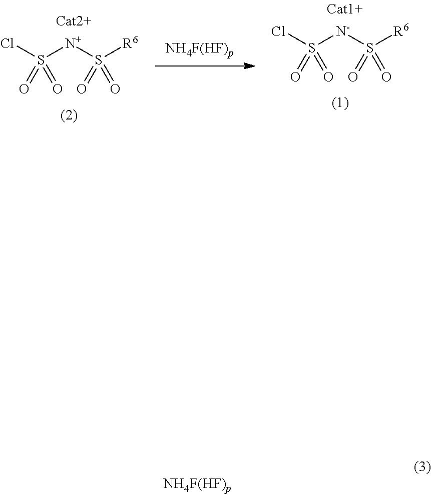

where R¹ is a C₁₋₆ fluoroalkyl group, R⁶ is halogen or a C₁₋₆ fluoroalkyl group, Cat1⁺ and Cat2⁺ are monovalent groups and p is an integer of 1 to 10.

JP 2014201453 (in the name of Nippon Shokubai) describes a method for producing an alkali metal salt of fluorosulfonyl imide which comprises a step of synthesizing an alkali metal salt of fluorosulfonyl imide in the presence of a reaction solvent containing at least one solvent selected from the group consisting of a carbonate-based solvent, an aliphatic ether-based solvent, an ester-based solvent, an amide-based solvent, a nitro-based solvent, a sulfur-based solvent and a nitrile-based solvent and, subsequently concentrating an alkali metal salt solution of fluorosulfonyl imide by distilling off the reaction solvent in the coexistence of the reaction solvent and at least one poor solvent for the alkali metal salt of fluorosulfonyl imide selected from the group consisting of an aromatic hydrocarbon-based solvent, an aliphatic hydrocarbon-based solvent and an aromatic ether-based solvent, the concentration step includes the step of mixing the above poor solvent with the reaction solution containing the reaction solvent and an alkali metal salt of fluorosulfonyl imide.

Supercritical fluid extraction has been used for recycling purposes. Notably, US 2003/0186110 (in the name of ECO BAT INDIANA LLC, ONTO TECH LLC), CN105406146 (in the name of HARBIN INST TECHNOLOGY) and CN110534835 (in the name of University of Changzhou) disclose a method for removing an electrolyte from an energy storage (e.g., a Lithium battery) using supercritical fluids.

Supercritical fluid extraction has also been described in connection with the extraction of bis(fluorosulfonyl)imide (HFSI) from reaction mixtures comprising acids. Notably, WO 2021/082450 (in the name of GUANGZHOU LIWEN TECH CO LTD) discloses a method for purifying HFSI from a reaction mixture comprising a strong acid (e.g., concentrated sulfuric acid, phosphoric acid) and a FSI salt (e.g., NaFSI, KFSI or LiFSI among others) using supercritical extraction, in particular supercritical CO₂ fluid. Also, CN111517293 (in the name of SHANGHAI INST ORGANIC CHEMISTRY CAS) describes a method for preparing HFSI using supercritical fluid which comprises the following steps:

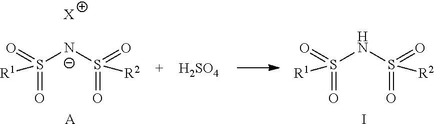

wherein X is an alkali metal; R¹ and R² are independently F or all-F substituted C1-12 alkyl.

### SUMMARY OF THE INVENTION

As described in the literature, the production of LiFSI by fluorination takes place in solvents, for example organic solvents, in order to disperse the reactive entities and allow them to react.

However, such solvents need to be removed after reaction to obtain an as pure as possible product which can be used for battery applications.

The Applicant is aware that the step for preparing a solid form LiFSI based on a LiFSI in solution is complex, especially because the amount of remaining solvent must be as low as possible in order to be well suited for battery electrolytes.

Thus, the Applicant faced the problem of developing a new process for the manufacture of LiFSI, which allows overcoming the complexities of the method known to date.

Unexpectedly, the Applicant developed a process for the manufacture of LiFSI, which is simple to perform in terms of apparatus and reaction conditions and very friendly from an environmental perspective.

Also, the process of the present invention allows to obtain LiFSI in solid form with a very high yield and high purity, such that it can be then used in a battery electrolyte solution.

The advantageous process for preparing LiFSI in solid form according to the present invention is based on extraction with supercritical fluid, herein said supercritical fluid acts as an anti-solvent for the LiFSI.

An object of the present invention is hence a process for preparing a LiFSI in solid form from a solution comprising at least one solvent and LiFSI salt, such process being based on the use of supercritical fluid.

### DRAWINGS

FIG. 1 represents a scheme of the laboratory setup used in Example 2.

### DISCLOSURE OF THE INVENTION

In the present application:
the expression “comprised between . . . and . . . ” should be understood as including the limits;
any description, even though described in relation to a specific embodiment, is applicable to and interchangeable with other embodiments of the present invention;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents.

A first object of the present invention relates to a process for preparing lithium salt of bis(fluorosulfonyl)imide (LiFSI) in solid form, comprising the steps of:
a) injecting a supercritical fluid in a vessel;
b) optionally, injecting a solvent S in said vessel;
c) injecting a LiFSI solution comprising LiFSI and at least one solvent S in said vessel;
d) contacting the LiFSI solution with said at least one supercritical fluid and said solvent S in said vessel; and
e) recovering the LiFSI in solid form.

The term “injecting” or “inject” or “injection” hereby means that the fluid, the solvent, and the solution described herein are placed in a vessel (also called recipient or device), wherein the various components involved in the process will be contacted in order for the LiFSI to precipitate. Within the context of the present invention, “injecting the fluid/solvent/solution in the vessel” can notably be equivalently replaced by “adding the fluid/solvent/solution in the vessel” or by “feeding the fluid/solvent/solution in the vessel”.

The term “contacting” hereby means that the solution is in contact with the supercritical fluid in the vessel, under specific conditions of pressure and temperature, for a time sufficient for the fluid to remove at least part of the solvent present in the LiFSI solution, preferably more than 80.0%, more than 90.0%, more than 95.0%, more than 99.0%, more than 99.5% or even more than 99.9% of the solvent. This time is sufficient to allow the LiFSI to precipitate in the vessel.

The term “recovering” hereby means that the LiFSI in solid form is removed or extracted from the vessel wherein the process takes place.

The term “supercritical fluid” hereby means a gas in its supercritical state. Depending on the gas employed in step a), certain pressures and temperatures may be used in the vessel where the contact between the solution and the supercritical fluid takes place. More precisely, in order to be in a supercritical state, the gas employed in step a) is held at or above its critical temperature and critical pressure.

The term “vessel” hereby means a container, which is well suited for the process of the present invention, that-is-to-say adapted to withstand the pressures and temperatures used in the process of the present invention, as well as to the possible corrosive character of the reactants and products involved in this process. As detailed below, the vessel used herein can notably be an extraction column (also referred to as “column”) or an autoclave.

According to the process of the present invention, supercritical fluid is used to extract the LiFSI salt from the solution, with several advantages. Supercritical fluids, such as sCO₂, offer clear advantages, are usually easily available, inexpensive, non-toxic, non-explosive, and not organic solvents. Additionally, the process of the present invention operates at a moderate temperature (below 100° C.), which ensures a gentle treatment of the LiFSI product. The process of the present invention also allows an easy separation of the solvent(s) and the solid form extract. The process of the present invention offers additional advantages, which are described below, including the possibility to fine tune the size of the LiFSI salt obtained from the process of the present invention.

Preferably, the process according to the present invention is carried out in a vessel at a pressure P of at least 73 bars (7.3 MPa).

Preferably, the process according to the present invention is carried out in a vessel at a temperature T between 30° C. and 90° C.

The temperature T in the vessel may vary between 37° C. and 75° C., for example between 38° C. and 70° C. or between 40° C. and 65° C.

The pressure P in the vessel may be at least 80 bars (8.0 MPa), at least 100 bars (10.0 MPa), at least 130 bars (13.0 MPa) or at least 150 bars (15.0 MPa). A very high pressure can be used also in the process of the present invention for example, the pressure P in the vessel may be up to 200 bars (20.0 MPa) or 300 bars (30.0 MPa). The pressure in the vessel will usually be less than 500 bars (50.0 MPa), for example less than 450 bars (45.0 MPa), less than 400 bars (40.0 MPa), or even less than 350 bars (35.0 MPa).

Preferably, each of said at least one supercritical fluid, solvent S and LiFSI solution are injected in the vessel through injectors or entry valves which are mounted on the vessel. Each of them may be injected in the vessel through the same injector or entry valve, or through distinct ones.

Each of said at least one supercritical fluid, solvent S and LiFSI solution may independently be injected in the vessel after the vessel is heated and/or pressurized.

When step b) is performed, preferably, steps a) and b) are carried out simultaneously. The injections of the supercritical fluid and the solvent S according to this embodiment may be performed through the same entry valve or injector (coaxial nozzle may for example be used), or they may be performed through distinct entry valves or injectors (two or more).

Alternatively, step b) is started after step a). The injection of the supercritical fluid according to step a) may be preferably continued when the solvent S starts to be injected in the vessel at the beginning of step b). Alternatively, the injection of the supercritical fluid according to step a) may be stopped briefly and re-started after a certain period of time. As disclosed above, the injections of the supercritical fluid and the solvent S according to these embodiments may be performed through the same entry valve or injector, or they may be performed through distinct entry valves or injectors (two or more).

The supercritical fluid and the solvent S are mixed together when both steps a) and b) are carried out.

Solvent S of step b) and the solvent S in the LiFSI solution of step c) can be the same or different from each other. Preferably, Solvent S of step b) is the same as the solvent S in the LiFSI solution of step c).

According to step c), the LiFSI solution comprising the LiFSI and solvent S is injected in the vessel. The LiFSI solution involved in the process of the present invention may be directly obtained from a LiFSI preparation process (as for example described in the experimental part of the present invention), or it may be a commercial product.

Under step c) of the present invention, the LiFSI solution is injected into the vessel containing at least one supercritical fluid.

Under step c), the LiFSI solution can be injected into the vessel via proper means, such as for example a nozzle or injector. According to a preferred embodiment, a capillary pipe can be used to inject said LiFSI solution. Other means to inject said LiFSI solution can be used, such as an atomization nozzle.

According to a preferred embodiment, the process of the present invention comprises step a) and step c). In other words, step b) is not performed. Under this embodiment, the LiFSI solution is injected into the vessel containing the supercritical fluid. Such injection is performed with a high flow rate for a short period of time, which facilitates the mixing with the supercritical fluid in the vessel.

Alternatively, the process of the present invention comprises: step a), optionally step b) and step c), wherein step a), step c) and the optional step b) are performed at the same time. Under this embodiment, the LiFSI solution is injected in the vessel simultaneously with the supercritical fluid and optionally with the solvent S. For example, and especially preferably at industrial scale, coaxial nozzles are used for the simultaneous introduction of supercritical fluid and LiFSI solution in the vessel.

Still alternatively, the process of the present invention comprises: step c), step a) and optionally step b). Under this embodiment, the LiFSI solution is injected in the vessel before any one of the supercritical fluid and optionally solvent S. Preferably, the LiFSI solution is introduced in the vessel first and then the vessel is heated and put under pressure, and then said supercritical fluid and optionally solvent S are injected.

Preferably, step a) is performed by injecting the supercritical fluid at the bottom of the vessel. Advantageously, this allows improving the mixing of the LiFSI solution with the supercritical fluid.

According to an embodiment, when step b) is performed, step b) is stopped when step c) is started. In other words, the feed of solvent S in the vessel is replaced by a feed of the LiFSI solution. For example, the entry valve or injector to inject the solvent S in the vessel may be closed while the entry valve or injector to inject the LiFSI solution in the vessel is open. Alternatively, the same entry valve or injector is used for the feed of solvent S and LiFSI solution; in other words, the feed of LiFSI solution is injected in the vessel through the same entry valve or injector than the solvent S.

As explained, during the process of the invention, the LiFSI solution is contacted with at least one supercritical fluid.

Preferably, the LiFSI solution is contacted with one fluid in a supercritical state.

Preferably, the LiFSI solution is contacted with two or more fluids in a supercritical state. Said two or more fluids may be mixed or may be contacted with the LiFSI solution sequentially. As an example, the LiFSI solution may be contacted with a mixture of at least two supercritical fluids.

Additionally, according to the present invention, at least one other component, also called herein modifier, may be mixed to the supercritical fluid(s).

Preferably, said at least one other component is selected from polar solvents having a solubility in the supercritical fluid below 10 wt. % based on the total weight of the supercritical fluid and the other component(s).

More preferably, when used, said at least one other component is in an amount ranging from 0.1 to 10.0 wt. %, for example from 0.5 to 8.0 wt. % or from 1.0 to 6.0 wt. %, based on the total weight of the supercritical fluids plus the other component(s).

Preferably, said at least one other component is selected from polar solvents, more preferably in the group comprising: alcohol, toluene, dimethyl sulfoxide (DMSO), acetonitrile and the like. According to a preferred embodiment, said polar solvent is alcohol. Even more preferably, said alcohol is ethanol.

Preferably, the supercritical fluid used in step a) comprises supercritical carbon dioxide (sCO₂). sCO₂ is a fluid state of carbon dioxide that is held at or above its critical temperature (31.0° C.) and critical pressure (7.3773 MPa).

Advantageously, the supercritical fluid used in step a) consists essentially in sCO₂, or it consists in sCO₂.

According to an embodiment, the sCO₂ is mixed with up to 10 wt. % of ethanol, for example with 0.1 to 8 wt. % of ethanol, the wt. % being based on the total weight of the supercritical fluid and the ethanol.

The weight ratio of the supercritical fluid to the LiFSI solution used in the process of the present invention may vary between 1/1 and 4000/1. For example, the weight ratio supercritical fluid/LiFSI solution preferably varies between 10/1 and 3500/1.

It will be clear to those skilled in the art that the parameters of the process according to the present invention can be properly selected and optimized based for example on the starting material (in particular, on the purity of the product) and on the scale at which the process is performed, for example is the process is performed at industrial scale or at laboratory scale.

Preferably, when the process of the present invention is performed at laboratory scale, the mass ratio between the supercritical fluid and the solution containing LiFSI is:
between 21 and 1500 when the injection of the solution containing LiFSI is continuous; or
between 350 and 3100 when the injection of the solution containing LiFSI is non-continuous or batch wise.

Preferably, when the process of the present invention is performed at industrial scale, the mass ratio between the supercritical fluid and the solution containing LiFSI is below 300, when the injection of the solution containing LiFSI is continuous.

Good results were obtained at laboratory scale, as demonstrated in the experimental section below, injecting the supercritical fluid, preferably comprising or consisting in sCO₂, in the vessel, at a flow rate between 5 and 50 g/min, preferably between 10 and 40 g/min, for example at about 30±5 g/min.

Good results were obtained at laboratory scale, by injecting, under step a), sCO₂ in a vessel at a flow rate between 5 and 50 g/min, preferably about 30±5 g/min.

Good results were obtained at laboratory scale, by injecting, under step b), said at least one solvent S in the vessel at a flow rate of less than 1 mL/min, or less than 0.5 mL/min, preferably less than 0.1 mL/min.

The solution containing the LiFSI comprises one solvent S or two or more solvents S, for example a mixture of two or three solvents S.

Preferably, said solvent S is selected from the group comprising, more preferably consisting of: ethylene carbonate, propylene carbonate, butylene carbonate, γ-butyrolactone, γ-valerolactone, dimethoxymethane, 1,2-dimethoxyethane, tetrahydrofuran, 2-methyltetrahydrofuran, 1,3-dioxane, 4-methyl-1,3-dioxolane, methyl formate, methyl acetate, methyl propionate, dimethyl carbonate, ethyl methyl carbonate, diethyl carbonate, sulfolane, 3-methylsulfolane, dimethylsulfoxide, N,N-dimethylformamide, N-methyl oxazolidinone, acetonitrile, valeronitrile, benzonitrile, ethyl acetate, isopropyl acetate, n-butyl acetate, nitromethane, nitrobenzene, trifluoroethanol and mixtures thereof.

More preferred solvents include ethylene carbonate, propylene carbonate, butylene carbonate, tetrahydrofuran, dimethyl carbonate, ethyl methyl carbonate, diethyl carbonate, ethyl acetate, isopropyl acetate and n-butyl acetate. Even more preferred solvents include dimethyl carbonate, ethyl methyl carbonate, diethyl carbonate, ethyl acetate, isopropyl acetate and n-butyl acetate. Still more preferred solvents include ethyl methyl carbonate and n-butyl acetate. The most preferred solvent is ethyl methyl carbonate.

In some embodiments, the LiFSI solution comprises between 5 and 70 wt. % of LiFSI, based on the total weight of the solution.

The LiFSI solution preferably comprises between 10 and 60 wt. % of LiFSI, for example between 15 and 50 wt. %, between 20 and 40 wt. % or between 25 and 35 wt. %. As an example, the solution comprises 30±2 wt. % of LiFSI.

Good results were obtained at laboratory scale, by injecting under step c) the LiFSI solution in the vessel at a flow rate of less than 3 mL/min, less than 2.5 mL/min, preferably less than to or equal to 2 mL/min.

Under step c), the LiFSI solution may be provided sequentially, either semi-continuously or continuously. In other words, the LiFSI solution is continuously injected in the vessel or the LiFSI solution is semi-continuously injected in the vessel. For example, the LiFSI solution may be injected in the vessel for a certain time, such as for example between 30 and 120 seconds, preferably for about 60 seconds, and then the injection is stopped for another period of time, which can be equal to, shorter or longer than the injection time. The LiFSI solution to be converted into a solid form may be injected in the vessel in 5 times, 4 times, 3 times, 2 times or all at once.

A particular advantage of the process of the present invention is that the contacting time under step d) is short. Also, advantageously, the contacting time under step d) can be properly selected for example on the basis of the starting material and the desired yield.

Preferably, the contacting time under step d) varies between a few seconds, for example 5 seconds, and 24 hours. More preferably, the contacting time under step d) varies between 1 minute and 12 hours, for example between 5 minutes and 10 hours or between 10 minutes and 5 hours.

When step d) is finished, the LiFSI in solid form is recovered under step e).

Preferably, the LiFSI in solid form recovered under step e) is in the form of a powder.

Preferably, step e) is performed by continuously or semi-continuously withdrawing the solid LiFSI from the vessel.

According to a specific embodiment of step e), the solid LiFSI is recovered and separated from the supercritical fluid. The pressure is released and the supercritical fluid becomes a gas. Such gas is preferably recycled, as detailed below.

While the reaction conditions are controlled, at least a part of the LiFSI in the LiFSI solution injected in step c) might not precipitate and hence part of the LiFSI solution remains in the vessel in admixture with the supercritical fluid. It will be understood by those skilled in the art that the LiFSI solution remaining in the vessel has a concentration of LiFSI lower than the LiFSI solution provided in step c).

According to this embodiment, the mixture comprising the supercritical fluid, at least a part of the LiFSI solution and optionally the solvent S is reinjected into the vessel as such.

Alternatively, the mixture comprising the supercritical fluid, at least a part of the LiFSI solution and optionally the solvent S is injected into a second vessel. In said second vessel, the pressure is released thus obtaining a gas, which can be further recycled into the process, and a solution of LiFSI and at least one solvent S, which can be further re-used in the process of the present invention.

The process of the present invention may be carried out in a batch mode, in a continuous or semi-continuous mode. Preferably, it is carried out in a continuous or semi-continuous manner.

The process of the present invention may further comprise additional steps.

For example, the process of the present invention may comprise, after step d), a step d′) consisting in injecting at least one supercritical fluid in the vessel. This additional step has the advantage of dry out the LiFSI in solid form before recovering it under step e).

Preferably, said step d′) is performed at a pressure P of at least 73 bars and a temperature T between 10° C. and 90° C. After step d′), the vessel can then be depressurized and the solid LiFSI product be recovered under step e).

The process of the present invention may also comprise after step d), step d′) or step e), at least one step consisting in recycling the solvent S and/or recycling the supercritical fluid.

The process of the present invention preferably comprises recycling of the solvent S and the recycling of the supercritical fluid.

Preferably, the supercritical fluid may be re-injected in the process of the present invention as such or after additional step(s) of purification.

Preferably, the recycled solvent S may be reused in a different process, for example the upstream process to prepare the LiFSI salt.

The recycling of the solvent S and the supercritical fluid may be performed in several ways.

According to a first embodiment, the supercritical fluid may be recycled in a continuous way during the process using a supercritical fluid pipe under pressure.

According to a second embodiment, the solvent S may be recovered as a liquid phase by releasing the pressure in the vessel, and then re-pressurizing the gas, for example by means of a compressor, in order to recycle it as a supercritical fluid which can be rejected in the vessel.

The process of the present invention may be carried out in an equipment comprising:
a gas tank and a supercritical gas generator;
optionally, a solvent S tank;
a LiFSI solution tank;
a vessel, which can withstand a pressure P of at least 50 bars (5.0 MPa) and a temperature T above 10° C.;
a device to mix the supercritical fluid and the LiFSI solution, for example an atomization nozzle;
at least two injectors mounted on the vessel; and
a solvent trap;
optionally a separator; and
optionally a filtration device.

The vessel may preferably be made of sapphire, SS316L, glass or graphite filled PTFE.

The vessel can notably be a column or an autoclave.

The equipment may include a separator. Different separators may be used in the process of the present invention. In some embodiments, the separation of the liquid and the gas/fluid may be carried out through traditional filtration (also referred to as “dead end filtration”) or cross filtration, which is also called tangential filtration, as disclosed for example in US 2007/0021570 (in the name of Solvay SA.). Alternatively, cyclonic separators may be used, for example those which operate as liquid/solid or gas/solid separators. The cyclonic separators are advantageous because allow recovering the solids, which could plug the filter media. Several hybrid devices exist based on this principle. Reference can notably be made to U.S. Pat. No. 7,410,620 (in the name of North Carolina State University).

For example, said frit filter can be made of stainless steel. Preferably, said frit filter has at least one of the following characteristics: pore size between 1 and 6 μm, preferably from 2 to 4 μm; diameter between 1 and 20 mm, preferably between 5 and 15 mm, more preferably about 10 mm; and/or a thickness from 0.1 to 5 mm, preferably between 0.7 and 3.5 mm, more preferably between 1.5 and 2.5 mm.

If the equipment comprises a filter, or several filters, the filter(s) may notably be positioned at the bottom or at the top of the vessel.

In an exemplary embodiment of the present invention, the process for preparing a LiFSI salt in solid form can be performed at laboratory scale and comprises:
a*) injecting sCO₂ in a vessel at a flow rate comprised between 5 and 50 g/min, preferably about 30±5 g/min, wherein the vessel is at a pressure P of at least 73 bars and a temperature comprised between 1° and 90° C., preferably a pressure P of 200±10 bars and a temperature of 40±5° C.;
b*) injecting a solvent S in the vessel at a flow rate of less than 1 mL/min, preferably less than 0.1 mL/min;
c*) stopping the injection of solvent S according to step b) and injecting the LiFSI solution in the vessel at a flow rate of less than 3 mL/min, preferably less than to or equal to 2 mL/min, wherein the LiFSI solution is discontinuously injected in the vessel, for example less than 5 times through the entire process;
d*) contacting the LiFSI solution with the supercritical fluid and the solvent S in the vessel for a period of time of between 5 minutes and 24 hours, preferably less than 5 hours; and
e*) recovering the LiFSI in solid form.

A second object of the present invention relates to the lithium salt of bis(fluorosulfonyl)imide (LiFSI) in solid form obtainable by the process of the present invention.

Advantageously, such LiFSI salt in solid form is characterized in that it contains less than 100 ppm of water, as measured according to the KF method (oven).

Preferably, the amount of water is less than 50 ppm, less than 40 ppm, less than 30 ppm, less than 20 ppm, less than 10 ppm or even less than 5 ppm, as measured according to the KF method (oven).

Such LiFSI salt in solid form is also characterized in that the amount of solvent S in the salt is less than 50 ppm, as measured by Li NMR. The amount of solvent S in the LiFSI in solid form, for example in powder form, is preferably less than 40 ppm, less than 30 ppm, less than 20 ppm, less than 10 ppm or even less than 5 ppm.

Preferably, said LiFSI salt in solid form is characterized in that it contains at least one other substance. Said other substance if preferably:
fluoride (F⁻) preferably in an amount less than 100 ppm, as measured by Ionic Chromatography (IC); and/or
chloride (Cl⁻) preferably in an amount less than 100 ppm, as measured by IC; and/or
sulfate (SO₄²⁻) preferably in an amount less than 1,000 ppm, as measured by IC; and/or
sulfamate (NH₂SO3⁻) preferably in an amount less than 1,000 ppm, as measured by IC; and/or
fluorosulfonate (FSO₃⁻) preferably in an amount less than 1,000 ppm, as measured by IC.

Advantageously, the amounts of such other substances in the LiFSI salt in solid form recovered from the process of the present invention are preferably as follows:
fluoride (F⁻) in an amount up to 50 ppm, for example less than 40 ppm, less than 30 ppm, less than 25 ppm;
chloride (Cl⁻) in an amount up to 50 ppm, for example less than 40 ppm, less than 30 ppm, less than 20 ppm, less than 10 ppm or even less than 8 ppm;
acid substances different from sulfate (SO₄²⁻) in an amount up to 100 ppm, for example less than 50 ppm, less than 30 ppm, less than 25 ppm;
acid substances different from sulfate (SO₄²⁻) in an amount up to 100 ppm, for example less than 50 ppm, less than 30 ppm, less than 10 ppm, less than 5 ppm;
the amounts being measured by Ionic Chromatography (IC).

Preferably, said acid substances different from sulfate (SO₄²⁻) are selected from NH₂SO₃⁻ and/or FSO₃⁻.

Preferably, said acid substances different from sulfate (SO₄²⁻) are in the following amounts:
less than 50 ppm of sulfamate (NH₂SO₃⁻), for example less than 40 ppm, less than 30 ppm, less than 20 ppm, less than 10 ppm or even less than 5 ppm as measured by IC; and/or
less than 50 ppm of fluorosulfonate (FSO₃⁻), for example less than 40 ppm, less than 30 ppm, less than 20 ppm, less than 10 ppm or even less than 5 ppm as measured by IC.

The LiFSI salts of the present invention also preferably exhibit at least one of the following contents of chemical entities:
an iron (Fe) content of below 1,000 ppm, preferably below 500 ppm, more preferably below 100 ppm;
a chromium (Cr) content of below 1,000 ppm, preferably below 500 ppm, more preferably below 100 ppm;
a nickel (Ni) content of below 1,000 ppm, preferably below 500 ppm, more preferably below 100 ppm;
a zinc (Zn) content of below 1,000 ppm, preferably below 100 ppm, more preferably below 10 ppm;
a copper (Cu) content of below 1,000 ppm, preferably below 100 ppm, more preferably below 10 ppm;
a bismuth (Bi) content of below 1,000 ppm, preferably below 100 ppm, more preferably below 10 ppm;
a sodium (Na⁺) content of below 10,000 ppm, preferably below 5 000 ppm, more preferably below 500 ppm or even below 100 ppm; and/or
a potassium (K⁺) content of below 10,000 ppm, preferably below 5 000 ppm, more preferably below 500 ppm or even below 100 ppm.

It is indeed an object of the present invention to provide a LiFSI salt with very low amounts of impurities. The LiFSI salt of the present invention preferably presents a purity of more than 99.50%, more than 99.60%, more than 99.70%, more than 99.80%, more than 99.90% and even more than 99.95%, as measured by Li-NMR.

A third object of the present invention relates to a powder comprising lithium salt of bis(fluorosulfonyl)imide (LiFSI) and at least one other substance, said at least one other substance being:
a solvent S preferably less than 50 ppm, as measured by Li NMR; and/or
water in an amount preferably less than 50 ppm, as measured by the KF analysis via an oven method; and/or
fluoride (F⁻) in an amount preferably less than 25 ppm; and/or
chloride (Cl⁻) in an amount preferably less than 8 ppm; and/or
sulfate (SO₄²⁻) in an amount preferably less than 20 ppm; and/or
acid substances different from sulfate (SO₄²⁻) preferably less than 1 ppm.

Preferably, said acid substances are selected from NH₂SO³⁻ and/or FSO₃⁻.

A fourth object of the present invention relates to the use of lithium salt of bis(fluorosulfonyl)imide (LiFSI) in the solid form according to the present invention, in a battery electrolyte solution.

A fifth object of the present invention is the use of supercritical anti-solvent extraction for preparing a lithium salt of bis(fluorosulfonyl)imide (LiFSI) in solid form, from a solution comprising the LiFSI and at least one solvent S.

Should the disclosure of any patents, patent applications, and publications which are incorporated herein by reference conflict with the description of the present application to the extent that it may render a term unclear, the present description shall take precedence.

The present invention will be now described in more detail with reference to the following examples, whose purpose is merely illustrative and not intended to limit the scope of the disclosure.

### EXAMPLES

### Example 1—Preparation of the LiFSI Solution

The process to prepare the LiFSI solution was as follows.

The process was carried out in a 1 L reactor under N₂ with stirring means, a double jacket for thermal regulation, a condenser, a pressure regulator means and a liquid or gas addition means. At room temperature, 577.18 g of ethyl methyl carbonate (EMC) were introduced, and 145.77 g of anhydrous NH₄F were suspended. 190.52 g of bis(chlorosulfonyl)imide of formula (Cl—SO₂)₂—NH (HCSI) were added gradually during 1 hour, and the mixture was heated to less than 75° under stirring during 18-20 hours. The mixture was cooled to room temperature and 0.945 g of 25% NH₄OH (aq) (ammonia water) were added. The obtained mixture was stirred at room temperature for 2 hours and then filtered.

The product was then concentrated to 866.18 g, and 247.5 g of concentrated solution was transferred to a glass reactor. 371.3 g of dichloromethane were slowly added for 1 hour. Precipitated NH₄FSI was filtered, washed with dichloromethane, and dried in a vacuum oven to afford 144.5 g of NH₄FSI as a white solid.

110.12 g of crystallized NH₄FSI was solubilized in 902.7 g EMC. 23.37 g of a 25 wt. % aqueous solution of LiOH·H₂O was added. The obtained biphasic mixture was stirred for 1 hour at room temperature, and then decanted. The organic phase was recovered and put into a thin film evaporator at 60° C. under reduced pressure (10⁻¹ bar).

A solution of 30 wt. % LiFSI in EMC was obtained.

### Example 2—Preparation of the LiFSI in a Powder Form Starting from the LiFSI Solution of Example 1

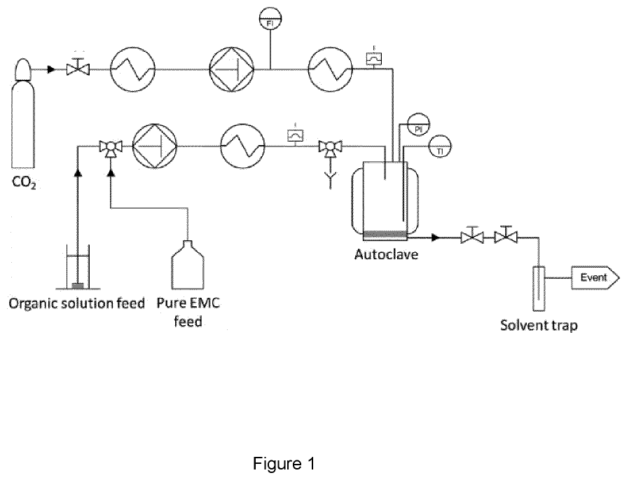

The equipment setup of FIG. 1 was used and the experiments were performed with the following procedures, using the detailed operating conditions summarized in Table 1.

The autoclave was filled with CO₂ at desired pressure (Pressure=80˜200 bar) and temperature (Temperature=35-50° C.) so as to provide supercritical CO₂ (sCO₂). During the experiment, the sCO₂ flowed continuously at a flow rate of 15-30 g/min (sCO₂ flow rate=15-30 g/min).

Pure EMC was then introduced (EMC flow rate=0-0.7 mL/min) and mixed with sCO₂ to achieve a steady state at the desired sCO₂/EMC mass ratio.

EMC feed was replaced with the LiFSI solution of example 1 (LiFSI solution flow rate=0-2 mL/min). The injection of the LiFSI solution was done either continuously, or discontinuously for 30-120 seconds per injection.

An injection of pure CO₂ was performed to dry out the powders. After depressurization of the autoclave, the powder recovered by the filter was obtained.

TABLE 1
operating conditions for the different experiments

| | | | | | | LIFSI | |
|---|---|---|---|---|---|---|---|
| | | | | CO₂ | EMC | solution | CO₂ |
| | LiFSI solution | P | T | flow rate | flow rate | flow rate | density |
| No. | injection | (bar) | (° C.) | (g/min) | (mL/min) | (mL/min) | (kg/m³) |
| 1 | Continuous | 80 | 35 | 15 | 0.7 | 1 | |
| 2 | | 120 | 35 | 30 | 0.7 | 1 | |
| 3 | | 200 | 35 | 30 | 0.7 | 1 | |
| 4 | | 200 | 35 | 30 | 0.35 | 0.5 | |
| 5 | | 200 | 35 | 30 | 0.04 | 0.06 | |
| 6 | | 200 | 35 | 30 | 0.02 | 0.03 | |
| 7 | Discontinuous | 100 | 40 | 30 | <0.01 | 1 | 605 |
| 8 | | 100 | 40 | 30 | <0.01 | 2 | 605 |
| 9 | | 200 | 40 | 30 | <0.01 | 1 | 843 |
| 10 | | 200 | 40 | 30 | <0.01 | 2 | 843 |
| 11 | | 200 | 50 | 30 | <0.01 | 2 | 730 |

### Results

Experiment 10 led to 50% of LiFSI salt (white and dry). It was obtained at the following conditions: 3 times of discontinuous LiFSI solution injection (30 s/injection), Pressure=200 bar, Temperature=40° C., CO₂ flow rate=30 g/min, EMC flow rate=0 mL/min, LiFSI solution flow rate=2 mL/min, CO₂/LiFSI solution mass ratio=30.

The water content was measured according to the KF analysis (oven method). The sample was prepared by a fully automated oven sample processor (Metrohm); sample weight 0.1 g, carrier gas=N₂, oven temperature=160° C. The titration was performed using a mixture of methanol and NH₄F (1:1 v/v). The polarization stream for potentiometric determination of reaction endpoint was 10 μA and titration endpoint voltage was 50 mV.

The water content in the LIFSI product of experiment 10 was lower than 50 ppm.

No main impurities were detected by Ion Chromatography (DIONEX ICS-3000):
F⁻<20 ppm
Cl⁻<5 ppm
SO₄²⁻<15 ppm
NH₂SO³⁻ n/d (not detected)
FSO₃⁻ n/d (not detected)

A purity of more than 99.9% was determined by Li-NMR.

1. A process for preparing a lithium salt of bis(fluorosulfonyl)imide (LiFSI) in solid form, comprising the steps of:
a) injecting a supercritical fluid in a vessel;
b) optionally, injecting a solvent S in said vessel;
c) injecting a LiFSI solution comprising LiFSI and at least one solvent S in said vessel;
d) contacting the LiFSI solution with said at least one supercritical fluid and said solvent S in said vessel; and
e) recovering the LiFSI in solid form.

2. The process according to claim 1, wherein said at least one supercritical fluid in step a) is selected from: one fluid in a supercritical state, or a mixture of at least two fluids in supercritical state.

3. The process according to claim 1, wherein;
step b) is not performed and step c) is started after step a); or
step b) is performed and step c) is started after step a) and step b) and solvent S injected in step b) is the same as solvent S in the LiFSI solution injected in step c).

4. The process according to claim 1, wherein said solvent S is selected from the group consisting of: ethylene carbonate, propylene carbonate, carbonate, butylene γ-butyrolactone, γ-valerolactone, dimethoxymethane, 1,2-dimethoxyethane, tetrahydrofuran, 2-methyltetrahydrofuran, 1,3-dioxane, 4-methyl-1,3-dioxolane, methyl formate, methyl acetate, methyl propionate, dimethyl carbonate, ethyl methyl carbonate, diethyl carbonate, sulfolane, 3-methylsulfolane, dimethylsulfoxide, N,N-dimethylformamide, N-methyl oxazolidinone, acetonitrile, valeronitrile, benzonitrile, ethyl acetate, isopropyl acetate, n-butyl acetate, nitromethane, nitrobenzene, trifluoroethanol and mixtures thereof.

5. The process according to claim 1, wherein the LiFSI solution comprises between 5 and 70 wt. % of LiFSI, based on a total weight of the solution.

6. The process according to claim 1, wherein the process is carried out in a vessel at a pressure P of at least 73 bars and/or a temperature T between 30° C. and 90° C.

7. The process according to claim 1, wherein said supercritical fluid(s) comprises CO₂, optionally in admixture with at least one polar solvent having a solubility in the supercritical fluid below 10 wt. % based on a total weight of said supercritical fluid and said at least one polar solvent.

8. The process according to claim 6, wherein:
the pressure P in the vessel ranges between 80 bars and 500 bars; and/or
the temperature in the vessel ranges between 35° C. and 80° C.

9. The process according to claim 1, wherein the process is carried out continuously or semi-continuously.

10. The process according to claim 1, further comprising at least one step of recycling the solvent S and/or recycling the supercritical fluid.

11. The process according to claim 1, said process being carried out in an equipment comprising:
a gas tank and a supercritical gas generator;
optionally, a solvent S tank;
a LiFSI solution tank;
a vessel which can withstand a pressure P of at least 50 bars and a temperature P above 10° C.;
a device to mix the supercritical fluid and the LiFSI solution;
at least two injectors mounted on the vessel; and
a solvent trap;
optionally a separator; and
optionally a filtration device.

12. The lithium salt of bis(fluorosulfonyl)imide (LiFSI) in solid form obtainable by the process of claim 1, characterized in that it contains less than 100 ppm of water, as measured according to the KF method (oven) and/or less than 50 ppm of solvent S.

13. A powder comprising lithium salt of bis(fluorosulfonyl)imide (LiFSI) and at least one other substance, said at least one other substance being:
a solvent S in an amount less than 50 ppm, as measured by Li NMR; and/or
water in an amount less than 50 ppm, as measured by the KF analysis via an oven method; and/or
fluoride (F⁻) in an amount less than 25 ppm, as measured by Ionic Chromatography (IC); and/or
chloride (Cl⁻) in an amount less than 8 ppm, as measured by IC; and/or
sulfate (SO₄²⁻) in an amount less than 20 ppm, as measured by IC; and/or
acid substances different from sulfate (SO₄²⁻) in an amount less than 1 ppm, as measured by IC.

14. A battery electrolyte solution formed with the lithium salt of bis(fluorosulfonyl)imide (LiFSI) of claim 12.

15. The process of claim 1, wherein during step d) the lithium salt of bis(fluorosulfonyl)imide (LiFSI) in solid form is prepared by a supercritical anti-solvent extraction, from a solution comprising LiFSI and at least one solvent S.

16. The process according to claim 1, wherein said solvent S is selected from the group consisting of: ethylene carbonate, propylene carbonate, butylene carbonate, γ-butyrolactone, γ-valerolactone, dimethoxymethane, 1,2-dimethoxyethane, tetrahydrofuran, 2-methyltetrahydrofuran, 1,3-dioxane, 4-methyl-1,3-dioxolane, methyl formate, methyl acetate, methyl propionate, dimethyl carbonate, ethyl methyl carbonate, diethyl carbonate, sulfolane, 3-methylsulfolane, dimethylsulfoxide, N,N-dimethylformamide, N-methyl oxazolidinone, acetonitrile, valeronitrile, benzonitrile, ethyl acetate, isopropyl acetate, n-butyl acetate, nitromethane, nitrobenzene, trifluoroethanol and mixtures thereof.

17. A battery electrolyte solution formed with the powder of claim 13.
